(19) United States
(12) Patent Application Publication
(10) Pub. No.: US 2022/0036238 A1
(43) Pub. Date: Feb. 3, 2022

(54) MONO CHANNEL BURST CLASSIFICATION USING MACHINE LEARNING

(71) Applicant: Tektronix, Inc., Beaverton, OR (US)

(72) Inventors: Karthikeyan R, Bengaluru (IN); Siby Charley P, Bengaluru (IN); John J. Pickerd, Hillsboro, OR (US); Saifee Jasdanwala, Portland, OR (US); Chandra Sekhar Kappagantu, Bengaluru (IN); Mahesh Nair M, Bengaluru (IN)

(73) Assignee: Tektronix, Inc., Beaverton, OR (US)

(21) Appl. No.: 17/386,400

(22) Filed: Jul. 27, 2021

(30) Foreign Application Priority Data
Jul. 30, 2020 (IN) 202021032802

(51) Int. Cl. G06N 20/00

(52) U.S. Cl. CPC G06N 20/00

(57) ABSTRACT

A system an input to receive a waveform signal, and one or more processors configured to execute code to cause the one or more processors to extract data bursts from the waveform signal, generate corresponding data vectors from the raw data for each data burst, and use machine learning to classify each data burst from the corresponding data vector. A method of classifying a data burst, comprising receiving an input waveform, extracting data bursts from the input waveform, deriving one or more spectral features of the data bursts, generating corresponding data vectors for each data burst from the one or more spectral features, and using machine learning to classify the data bursts from the corresponding data vectors.

### RELATED APPLICATIONS

This disclosure claims benefit of Indian Provisional Application No. 202021032802, titled “MONO CHANNEL BURST CLASSIFICATION USING MACHINE LEARNING,” filed on Jul. 30, 2020, which is incorporated herein by reference in its entirety.

### TECHNICAL FIELD

This disclosure relates to extraction of data bursts from waveforms, more particularly to using the data bursts to generate data vectors for classification by machine learning.

### BACKGROUND

In Double Data Rate Generation 5 (DDR5) memory, and previous DDR memory generations, the data transfers through a data bus. The bi-directional data bus supports data transfers between the memory controller and the dynamic random access memory (DRAM) chip. During data storage, the controller drives the data bus to write the data (Write burst) into the DRAM. Similarly, during the data read back, the DRAM outputs the data (Read burst) into the same data bus. In such a bi-directional data transfer design, detecting the correct read/write bursts and performing selective data analysis becomes complex.

Conventionally, the employed technique makes use of the DQS, or clock, waveform to identify the bursts as read or write. The data transfers generally consist of short bursts in byte lengths of 16/32/64 bits with every burst indicating either a read or write operation on to the memory. The signal characteristics vary between read and write. In order to carry any sort of compliance measurements, it becomes essential to identify the bursts as read or write. Typically, the use of the DQS signal to compute certain parameters allows identification of the burst type. While this technique works successfully, it requires a clock signal and a dedicated channel for it.

Embodiments of the disclosed apparatus and methods address shortcomings in the prior art.

### BRIEF DESCRIPTION OF THE DRAWINGS

FIG. 1 shows a test and measurement system.

FIG. 2 shows a method of classifying data bursts.

FIG. 3 shows an image of a data burst on a screen of a test and measurement device.

FIG. 4 shows short term Fourier transforms of read data bursts.

FIG. 5 shows short term Fourier transforms of write data bursts.

### DETAILED DESCRIPTION

The embodiments here generally comprise a method of classifying bi-directional signals using a single channel, for example, a single input channel of a test and measurement instrument, such as an oscilloscope. The embodiments perform signal processing on the signal burst to determine the signal's spectral features and use those features as inputs to a machine learning classifier to identify the signal. The embodiments here employ the machine learning-based technique applied to data waveforms to perform the read/write classification. The embodiments accomplish this using a single channel, signal processing features, and applied machine learning. The embodiments here discuss the differentiation between read and write bursts in DDR5, but the techniques here could apply to differentiation of signal bursts for other bi-directional signals.

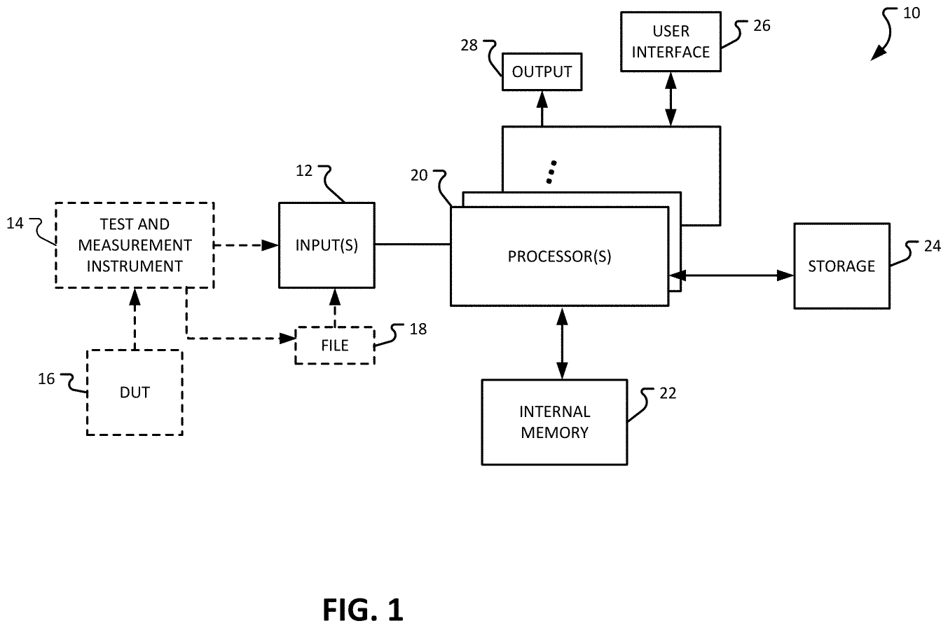

FIG. 1 shows an embodiment of a system configured to classify a data burst signal. The discussion here focuses on a determination of the signal being a read data signal or a write data signal, but as discussed above, the techniques may apply to other differential signals.

The system 10 has an input 12 to receive an input waveform. A test and measurement device 14, such as an oscilloscope, may receive the waveform from a device under test (DUT) 16 and pass the waveform to the system that will perform the classification. In some embodiments, the system that performs the classification and the test and measurement device may comprise the same device. In other embodiments, the test and measurement device may reside in a separate device from the classification system. In another embodiment, the waveform data may be provided to the classification system in the form of a data file 18. The classification system may comprise one or more processors 20 that may reside in a same computing device, or may be distributed across several different devices, some of which may be on a network in some embodiments.

The classification system may include a storage 24 that may reside in the same device or external to the device that contains the processor(s), such as a database or cloud storage. The classification system may also include an internal memory 22 that contains the instructions that cause the processors to perform the processes of the embodiments. This internal memory or the external storage may include the data sets used for training and validation, as well as the data undergoing classification. The system provides the results of the classification as an output such as 28. The user may interact with the system through a user interface 26. This user interface may be in addition to any user interface on the test and measurement device. The system 10, whatever the architecture, operates to classify data bursts.

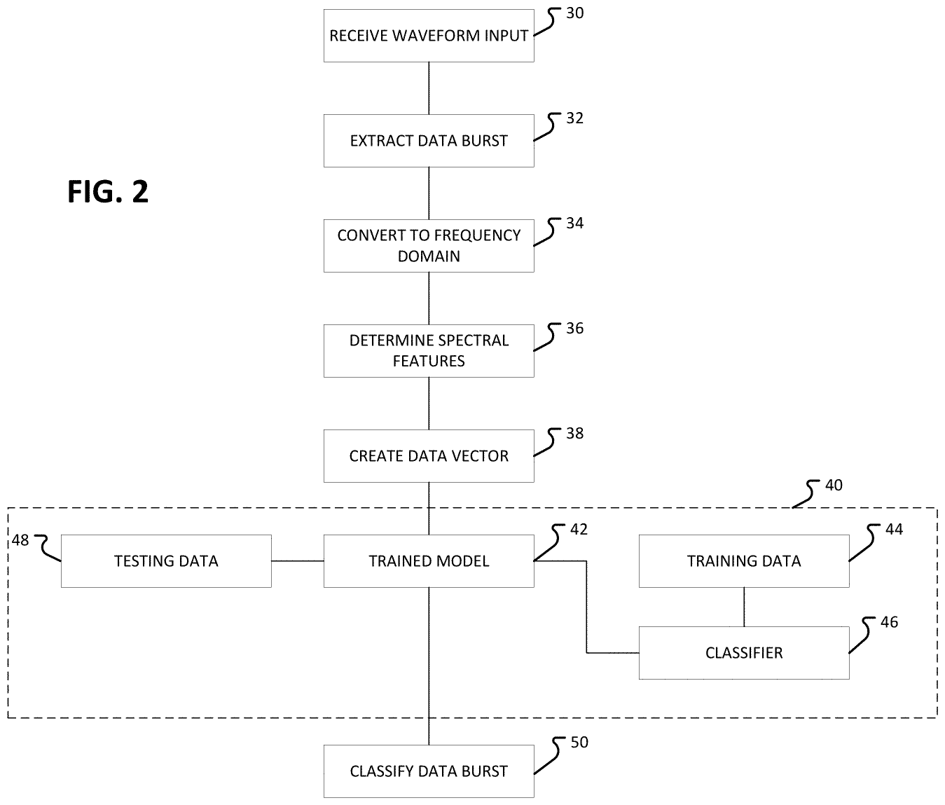

FIG. 2 shows a flowchart of an embodiment of a method of classifying data bursts, including pre-processing and feature engineering, described below, based on signal processing, and classification by machine learning (ML). The process receives the waveform input, either from a test and measurement device or a file, at 30. The embodiments perform a binary classification of the bursts. The process segregates out the bursts from the waveform of a given record length, stripping out and extracting the burst regions alone out of a given signal at 32. This extraction operation could be accomplished either in terms of amplitude shift or energy shift or both. The extraction quality need not be extremely accurate, a decent quality extraction would also suffice for the rest of the process blocks. The embodiments manipulate the signal into a format which is suitable for a feature extractor and machine learning classifier to operate.

The below formulation shows one embodiment of a formula used to extract samples

$${x}_{i} = \{ \begin{matrix}1 & if {\sum }_{i ∈ window}^{ } I ( sign ( {s}_{i} - {s}_{i + 1} ) ) > threshold \\ 0 & else\end{matrix}$$

where 1 indicates bursts and 0 non bursts, I is the indicator function giving 0 or 1 based positive or negative sign of the addressed operation, sᵢ is the i^{th} sample of the chosen window, with the definition of window=(burst length+6UI), burst length=16 UI, UI is the unit interval of the signal, and threshold, although configurable, initializes to 1 for comparison. The burst length depends on the specific DUT. For a DDR5 memory DUT for example, the burst length can vary like 16UI/32UI in-line with the DDR5 specifications.

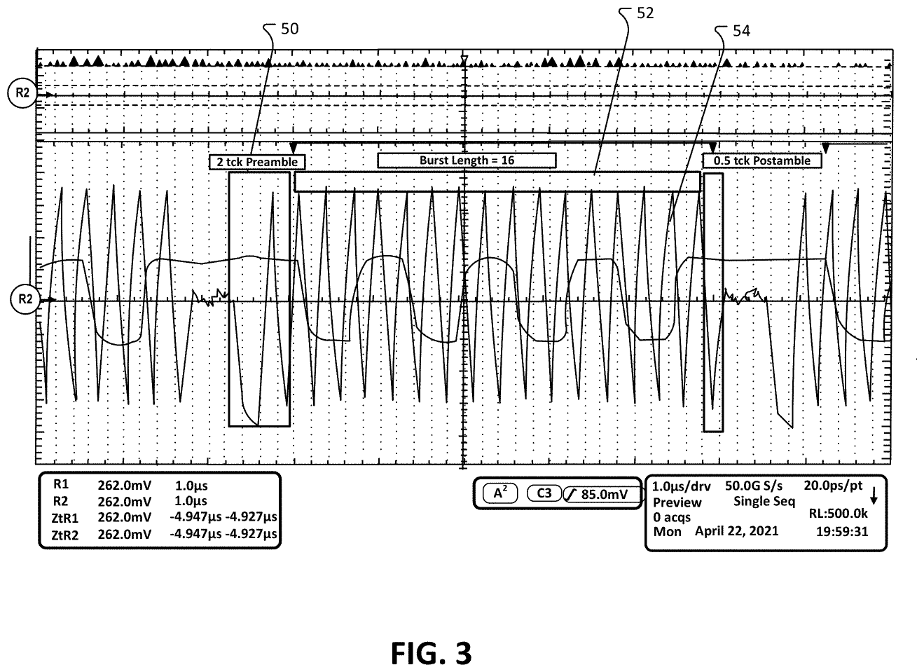

FIG. 3 shows a waveform representation for the burst window. In the lower legend box, R1 is the DQS waveform, and R2 is DQ waveform. As shown in FIG. 3, the data burst in the DQ waveform has a preamble 50, the actual burst signal 52, and then a postamble 54. The combination of the preamble, the burst, and the postamble, comprises the window. In this particular embodiment, the burst has a length of 16 UI.

Most ML-based classification tasks apply feature engineering where the idea is to come up with an abstract representation for the underlying data. In this case, feature engineering creates an abstract fixed vector for all the bursts in operation. The feature engineering procedure may take various forms, with the most common being deriving parameters/features that could act like differentiators between target classes from the raw data based on the domain knowledge.

The embodiments here use feature derivation from raw data, in this case being burst signals. The embodiments here, instead of using specific parameters relevant to DDR, approach feature derivation slightly differently by deriving features generic in nature to any one-dimensional (1D) signal. Embodiments use a set of frequency-based spectral features. The details of each feature are explained below.

In order to come up with spectral features, the process converts the extracted burst signal to the frequency domain at 34 in FIG. 2. Typically, frequency conversion involves a simple Fast Fourier Transform (FFT). However, with FFT applied onto the complete signal, the resulting conversion has high frequency resolution and poor time resolution. This leads to missing out details on data in the time domain. In order to overcome this problem, the process uses Short-Term Fourier Transform (STFT). STFT does overlapping time domain windowing and framing, and applies the FFT on every frame separately. This creates Time-Frequency two-dimensional (2D) representation with time along the X-axis and frequency along the Y-axis:

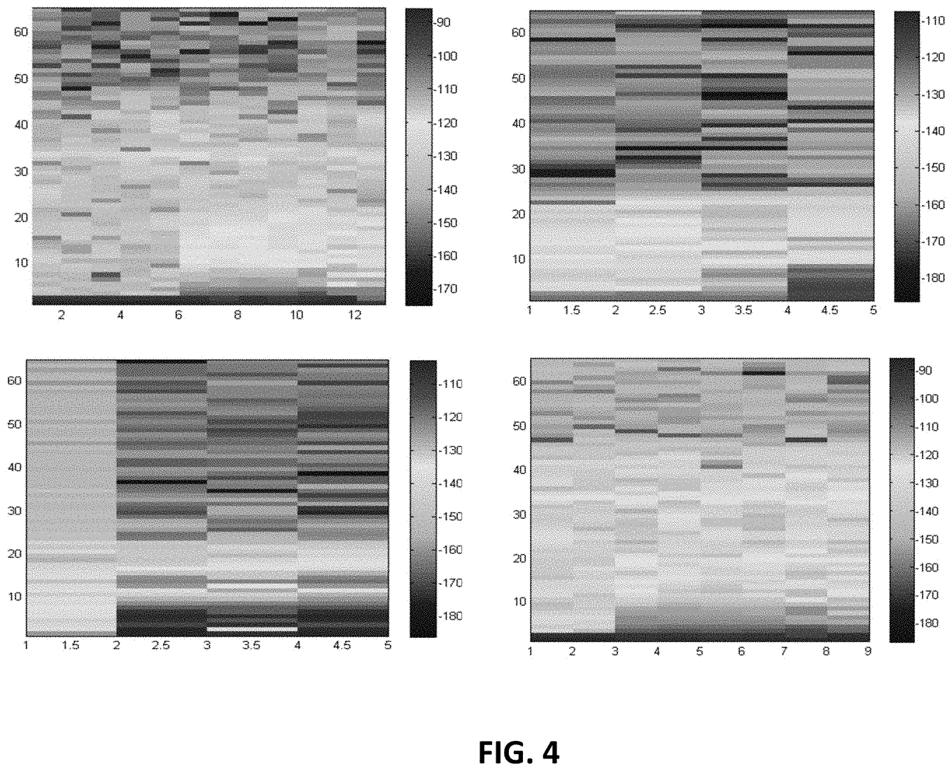

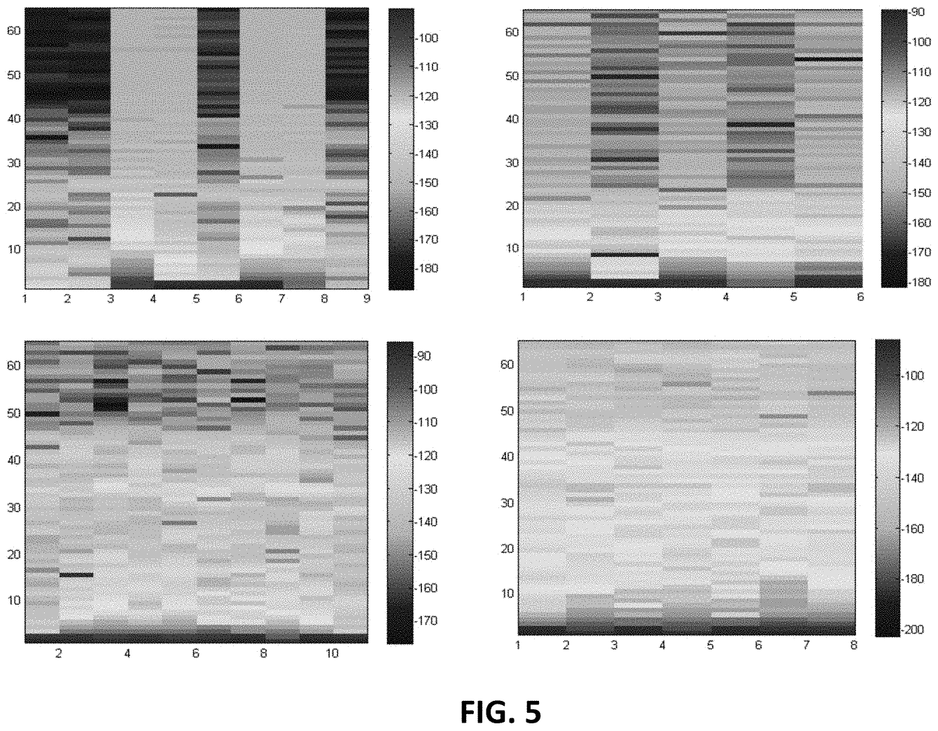

Sᵢₜ=FFT(frames(xᵢ))

where the upper case “S” denotes the frequency domain data for the i^{th} bin and t^{th} time frame, xᵢ is the input burst, frames gives the time domain framed snippets of input bursts and Sᵢₜ is the STFT represented data. FIG. 4 shows STFT results for read signals, and FIG. 5 shows STFT results for write signals, and show the spectrogram of the signal with time along X axis and frequency along the Y axis. The color/shades of gray indicates the intensity of the frequency domain in the decibel (dB) scale with higher intensity tending towards red and lower intensity towards blue. Different spectral features for the signals are determined at 36.

One spectral feature is energy, or the spectral magnitude computed on every time domain frame in the STFT data. This can be represented as

$${E}_{t} = sqrt ( \frac{M a g ( {S}_{i t} )}{N} )$$

where Eₜ is the spectral energy for t^{th} time frame, Sᵢₜ is the STFT data for the i^{th} frequency bin and t^{th} time frame, and N represents the number of frequency and bins.

Spectral flatness is the ratio of the arithmetic mean to the geometric mean of the frequency spectrum. The embodiments here compute it on a per frame basis giving flatness coefficients equivalent to the number of time domain frames. If the flatness coefficient is nearing to zero it indicates that spectrum is composed of all frequencies and is generally highly noisy with cleaner signals having fewer active ones:

$${F}_{t} = \frac{\sqrt[N]{{Π}_{i} \vert {S}_{i t} \vert}}{\frac{1}{N} {\sum }_{i}^{N} \vert {S}_{it} \vert}$$

where Fₜ is the spectral flatness for t^{th} time frame, Sᵢₜ is the STFT data for the i^{th} frequency bin and t^{th} time frame and N is the number of samples.

The centroid or spectral centroid defines the center of gravity of the frequency spectrum for any given time frame. Practically it is defined as the magnitude weighted mean of the normalized frequency spectrum in every time frame given as:

$${C}_{t} = \frac{{\sum }_{i = 1}^{N} {S}_{it} {Freq}_{i}}{{\sum }_{i = 1}^{N} {S}_{it}}$$

where Cₜ is the centroid for t^{th} time frame, Freqᵢ is the frequency value for the i^{th} bin and Sᵢₜ gives the STFT data for the i^{th} frequency bin and t^{th} time frame.

The spectral roll off identifies the center frequency of the frequency bin contributing to the majority, default is 85%, of energy in every time frame. The same can be represented as

Rₜ=Freq_{k=argmax(0.85*E}_{ₜ}_{=CMag}_{ᵢₜ}₎

where Rₜ is the spectral roll off for t^{th} time frame, Eₜ is the spectral energy for t^{th} time frame and CMagᵢₜ is the cumulative magnitude for the i^{th} frequency bin and t^{th} time frame.

The process creates a data vector at 38 in FIG. 2. The data vector may comprise a concatenation of at least two of spectral features of the signal, where the spectral features include, but are not limited to, those shown above. The embodiments discussed here concatenated all of the spectral features discussed above, but one does not have to use all of them. Fewer spectral features could be used, but may affect the probability of correctness of the determination.

Once the feature vector extraction is completed, the next step is to proceed with the classification of these feature vectors using machine learning 40. Some embodiments may use a random forest classifier, which comprises a collection of decision trees. The process prototyped on a very small dataset with few samples, making random forest a good selection due to ability to resist overfitting through aggregation. Overfitting results from a particular function fitting too closely to a small set of data points. Random forest creates an ensemble of decision trees with final classified label being the most voted one.

One should note that while some embodiments may employ a random forest classifier, and the discussion below focuses on random forest, no limitation to that particular classifier is intended, nor should any be implied. The discussion below provides an example of how the system may use a classifier, rather than limiting it to a random forest classifier.

Given a set of training samples of bursts and their respective class labels as {(x_{b}, y_{b})}_{b=1}^{N}, the random forest formulation of the classifier is given as

$$R {F}_{b} = max ( {\sum }_{i = 1}^{M} I ( {D}_{i} ) = 1 , {\sum }_{i = 1}^{M} I ( {D}_{i} ) = 0 )$$

where D indicates the decision tree, M gives the ensemble number of trees, I is an indicator function and RF_{b} represents the random forest classified label for the burst b. The model 42 is trained on the training data 44 to develop the classifier 46 appropriately and later tested on the held-out testing set at 48. This model then performs the classification of the data burst at 50.

One should note that while the discussion focuses on a random forest classifier, the process may use other classifiers. For example, given a set of data, {(x_{b}, y_{b})}_{b=1}^{N}, the generic formulation of burst classifier is defined as a nonlinear function learned over the input features and in turn predicting the output labels:

f:x_{b}→y_{b}

where, x_{b} ∈R^{d} is the d dimensional features corresponding to each of the b input bursts y_{b} ∈{0, 1} is the read and write labels corresponding to each of the b input bursts. The nonlinear functionality of the classifier is recommended due to the inherent nonlinearity of the input data unraveled through data explorations. Common nonlinear classifiers employed can be Support Vector Machines (SVM), and ensemble learning methods like random forest (Bagging) or Boosting, and neural networks.

All the bursts, irrespective of training or testing were subjected to pre-processing and feature engineering before performing the actual model training. The spectrogram, the short term Fourier transform, representation of each of randomly selected read/write bursts are as in FIGS. 4 and 5, and it is clear from the representation that there are ample variations in frequency spectrum indicating presence of learnable parameters that can be generated out of the spectrum.

In an experiment, the inventors trained the model on a dataset created from real world burst signals. The validation/testing was done on another set not used in training and obtained an average accuracy of approximately 90%.

In this manner, the system can perform burst detection using only one (mono) channel on the DQ bursts only. The embodiments perform burst detection using simple generic frequency domain parameters, not DDR-specific attributes. The approach is vendor and customer waveform agnostic, with the model dependent only on the sampling rate. The embodiments also provide an applied ML approach for burst detection.

The embodiments basically encompass a technique based on ML to classify burst signals into read/write for easier analysis. The embodiments look at the burst classification from a radically new angle employing only the DQ signal and using just basic frequency domain features. The system was developed and validated on a sample dataset with real world waveforms outlining the robustness of the technique.

Aspects of the disclosure may operate on a particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

Additionally, this written description refers to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

### EXAMPLES

Illustrative examples of the disclosed technologies are provided below. An embodiment of the technologies may include one or more, and any combination of, the examples described below.

Example 1 is a system, comprising: an input to receive a waveform signal; and one or more processors configured to execute code to cause the one or more processors to: extract data bursts from the waveform signal; generate corresponding data vectors from the raw data for each data burst; and use machine learning to classify each data burst from the corresponding data vector.

Example 2 is the system of Example 1, wherein the code to cause the one or more processors to extract data bursts in the waveform signal comprises code to causes the one or more processors to: identify a preamble to a data burst, and a postamble after a data burst; define a window that includes the preamble, the data burst, and a postamble, the data burst having a predetermined number of cycles; and set samples within the data burst equal to a 1 if the sample has a value of over a predetermined threshold and equal to a 0 if the sample is less than the threshold, to produce raw data for the data burst.

Example 3 is the system of either Examples 2 or 3, wherein the code to cause the one or more processors to generate corresponding data vectors from the raw data for each data burst comprises code to causes the one or more processors to derive features from the raw data.

Example 4 is the system of any of the Examples 1-3, wherein the code to cause the one or more processors to generate corresponding data vectors comprises code to cause the one or more processors to concatenate spectral features of the data into the corresponding data vectors.

Example 5 is the system of any of the Examples 1-4, wherein the code to cause the one or more processors to generate corresponding data vectors comprises code to cause the one or more processors to: apply a Short Term Fourier Transform (STFT) to the raw data to produce spectral data; determine one or more spectral features of the spectral data, including energy, flatness coefficient, centroid, and roll off; and concatenate one or more of the spectral features to produce the corresponding data vector.

Example 6 is the system of any of the Examples 1-5, wherein the code to cause the one or more processors to use machine learning to classify each data burst from the corresponding data vector comprises code to cause the one or more processors to use a random forest classifier.

Example 7 is the system of any of the Examples 1-6, wherein the code to cause the one or more processors to use machine learning further comprises code to cause the one or more processors to train a classifier using training data to produce a trained model.

Example 8 is the system of Example 7, wherein the code to cause the one or more processors to train a classifier using training data further comprises code to cause the one or more processors to validate the trained model.

Example 9 is the system of any of the Examples 1-8, wherein the code to cause the one or more processors to use machine learning to classify each data burst comprises code to cause the one or more processors to classify each data burst as one of either a memory read burst, or a memory write burst.

Example 10 is a method of classifying a data burst, comprising: receiving an input waveform; extracting data bursts from the input waveform; deriving one or more spectral features of the data bursts; generating corresponding data vectors for each data burst from the one or more spectral features; and using machine learning to classify the data bursts from the corresponding data vectors.

Example 11 is the method of Example 10, wherein extracting data bursts comprises: identifying a preamble to a data burst, and a postamble after a data burst; defining a window that includes the preamble, the data burst, and a postamble, the data burst having a predetermined number of cycles; and setting samples within the data burst equal to a 1 if the sample has a value of over a predetermined threshold and equal to a 0 if the sample is less than the threshold, to produce raw data for the data burst.

Example 12 is the method of either Examples 10 or 11, wherein generating corresponding data vectors comprises deriving features from the raw data.

Example 13 is the method of any of Examples 10-12, wherein generating corresponding data vectors comprises concatenating spectral features of the data into the corresponding data vectors.

Example 14 is the method of any of Examples 10-13, wherein generating corresponding data vectors comprises: applying a Short Term Fourier Transform (STFT) to the raw data to produce spectral data; determining one or more spectral features of the spectral data, including energy, flatness coefficient, centroid, and roll off; and concatenating one or more of the spectral features to produce the corresponding data vector.

Example 15 is the method of any of Examples 10-14, wherein using machine learning to classify each data burst from the corresponding data vector comprises using a classifier comprising one of random forest, Support Vector Machines, Boosting, and neural networks.

Example 16 is the method of any of Examples 10-15, wherein using machine learning further comprises training a classifier using training data to produce a trained model.

Example 17 is the method of Example 16, wherein using training data further comprises validating the trained model.

Example 18 is the method of any of Examples 10-16, wherein using machine learning to classify each data burst comprises classifying each data burst as one of either a memory read burst, or a memory write burst.

Example 19 is a system, comprising: an input to receive an incoming waveform; a burst extractor to extract data bursts from the waveform; a feature deriver to derive one or more spectral features from data in the data bursts; a data vector generator to generate data vectors from the one or more spectral features; and a machine learning system to use the data vectors to classify the data bursts.

Example 20 is the system of Example 19, wherein the data vector generator is configured to generate the data vectors by concatenating more than one spectral features.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific embodiments have been illustrated and described for purposes of illustration, it will be understood that various modifications may be made without departing from the spirit and scope of the disclosure. Accordingly, the invention should not be limited except as by the appended claims.

1. A system, comprising:
an input to receive a waveform signal; and
one or more processors configured to execute code to cause the one or more processors to:
extract data bursts from the waveform signal;
generate corresponding data vectors from the raw data for each data burst; and
use machine learning to classify each data burst from the corresponding data vector.

2. The system as claimed in claim 1, wherein the code to cause the one or more processors to extract data bursts in the waveform signal comprises code to causes the one or more processors to:
identify a preamble to a data burst, and a postamble after a data burst;
define a window that includes the preamble, the data burst, and a postamble, the data burst having a predetermined number of cycles; and
set samples within the data burst equal to a 1 if the sample has a value of over a predetermined threshold and equal to a 0 if the sample is less than the threshold, to produce raw data for the data burst.

3. The system as claimed in claim 1, wherein the code to cause the one or more processors to generate corresponding data vectors from the raw data for each data burst comprises code to causes the one or more processors to derive features from the raw data.

4. The system as claimed in claim 1, wherein the code to cause the one or more processors to generate corresponding data vectors comprises code to cause the one or more processors to concatenate spectral features of the data into the corresponding data vectors.

5. The system as claimed in claim 1, wherein the code to cause the one or more processors to generate corresponding data vectors comprises code to cause the one or more processors to:
apply a Short Term Fourier Transform (STFT) to the raw data to produce spectral data;
determine one or more spectral features of the spectral data, including energy, flatness coefficient, centroid, and roll off; and
concatenate one or more of the spectral features to produce the corresponding data vector.

6. The system as claimed in claim 1, wherein the code to cause the one or more processors to use machine learning to classify each data burst from the corresponding data vector comprises code to cause the one or more processors to use a random forest classifier.

7. The system as claimed in claim 1, wherein the code to cause the one or more processors to use machine learning further comprises code to cause the one or more processors to train a classifier using training data to produce a trained model.

8. The system as claimed in claim 7, wherein the code to cause the one or more processors to train a classifier using training data further comprises code to cause the one or more processors to validate the trained model.

9. The system as claimed in claim 1, wherein the code to cause the one or more processors to use machine learning to classify each data burst comprises code to cause the one or more processors to classify each data burst as one of either a memory read burst, or a memory write burst.

10. A method of classifying a data burst, comprising:
receiving an input waveform;
extracting data bursts from the input waveform;
deriving one or more spectral features of the data bursts;
generating corresponding data vectors for each data burst from the one or more spectral features; and
using machine learning to classify the data bursts from the corresponding data vectors.

11. The method as claimed in claim 10, wherein extracting data bursts comprises:
identifying a preamble to a data burst, and a postamble after a data burst;
defining a window that includes the preamble, the data burst, and a postamble, the data burst having a predetermined number of cycles; and
setting samples within the data burst equal to a 1 if the sample has a value of over a predetermined threshold and equal to a 0 if the sample is less than the threshold, to produce raw data for the data burst.

12. The method as claimed in claim 10, wherein generating corresponding data vectors comprises deriving features from the raw data.

13. The method as claimed in claim 10, wherein generating corresponding data vectors comprises concatenating spectral features of the data into the corresponding data vectors.

14. The method as claimed in claim 10, wherein generating corresponding data vectors comprises:
applying a Short Term Fourier Transform (STFT) to the raw data to produce spectral data;
determining one or more spectral features of the spectral data, including energy, flatness coefficient, centroid, and roll off; and
concatenating one or more of the spectral features to produce the corresponding data vector.

15. The method as claimed in claim 10, wherein using machine learning to classify each data burst from the corresponding data vector comprises using a classifier comprising one of random forest, Support Vector Machines, Boosting, and neural networks.

16. The method as claimed in claim 10, wherein using machine learning further comprises training a classifier using training data to produce a trained model.

17. The method as claimed in claim 16, wherein using training data further comprises validating the trained model.

18. The method as claimed in claim 10, wherein using machine learning to classify each data burst comprises classifying each data burst as one of either a memory read burst, or a memory write burst.

19. A system, comprising:
an input to receive an incoming waveform;
a burst extractor to extract data bursts from the waveform;
a feature deriver to derive one or more spectral features from data in the data bursts;
a data vector generator to generate data vectors from the one or more spectral features; and
a machine learning system to use the data vectors to classify the data bursts.

20. The system as claimed in claim 19, wherein the data vector generator is configured to generate the data vectors by concatenating more than one spectral features.
